(19) United States
(12) Patent Application Publication
(10) Pub. No.: US 2023/0154389 A1
(43) Pub. Date: May 18, 2023

(54) DISPLAY DEVICE

(71) Applicant: SAMSUNG DISPLAY CO, LTD., Yongin-si (KR)

(72) Inventors: YUNHWAN PARK, Seoul (KR); YONGJAE KIM, Seoul (KR); JIHYE KIM, Hwaseong-si (KR); YOONJEE SHIN, Hwaseong-si (KR)

(21) Appl. No.: 17/986,987

(22) Filed: Nov. 15, 2022

(30) Foreign Application Priority Data
Nov. 16, 2021 (KR) 1020210157593

(51) Int. Cl. G09G 3/32

(52) U.S. Cl. CPC G09G 3/32; G09G 2310/0278; G09G 2310/0267; G09G 2310/0275; G09G 2320/0247

(57) ABSTRACT

A display device includes a pixel connected to a first gate line, an emission control line, a bias gate line, and a data line. A gate driver is configured to supply a first gate signal to the first gate line in an address scan period and configured to supply a bias write gate signal to the bias gate line in a self-scan period. An emission driver is configured to supply an emission control signal in the address scan period and in a self-scan period. A data driver is configured to supply a first data voltage to the data line in the address scan period and configured to supply a second data voltage to the data line in the self-scan period. The second data voltage is set based on the first data voltage.

### CROSS-REFERENCE TO RELATED APPLICATION

Applicant claims priority from Korean Patent Application No. 10-2021-0157593, filed on Nov. 16, 2021, and all the benefits accruing therefrom under 35 U.S.C. § 119, the content of which is incorporated by reference in its entirety.

### TECHNICAL FIELD

The inventive concept relate generally to a display device. More specifically, exemplary embodiments of the inventive concept relate to a display device driven by variable frequency.

### DISCUSSION OF THE RELATED ART

A display device includes a plurality of pixels. Each of the pixels includes a plurality of transistors and a light emitting diode electrically connected to the transistors. The transistors are respectively turned on in response to signals supplied through lines, thereby generating a predetermined driving current. The light emitting diode emits light in response to the driving current.

A display device driven at a variable frequencies has been studied to enhance a driving efficiency of the display device and to minimize a power consumption. However, there remains a challenge in enhancing a display quality at the time when the frequency of the display device is changed.

### SUMMARY

Embodiments of the present inventive concept provide a display device driven with a variable frequency and having enhanced display quality.

A display device according to an embodiment of the present inventive concept may include a pixel connected to a first gate line, an emission control line, a bias gate line, and a data line, a gate driver configured to output a first gate signal to the first gate line in an address scan period and configured to output a bias write gate signal to the bias gate line in a self-scan period, an emission driver configured to output an emission control signal in the address scan period and a self-scan period, and a data driver configured to output a first data voltage and a second data voltage to the data line. The second data voltage may be set based on the first data voltage.

In an embodiment, the data driver is configured to output the first data voltage to the data line during the address scan period and configured to output the second data voltage to the data line during the self-scan period.

In an embodiment, the first data voltage and the second data voltage are set to stabilize a boundary light waveform of the pixel between the address scan period and the self-scan period.

In an embodiment of the present inventive concept, the second data voltage may be a same as the first data voltage.

In an embodiment of the present inventive concept, the second data voltage may be greater than the first data voltage by an offset voltage.

In an embodiment of the present inventive concept, the offset voltage may be about 0.2 V.

In an embodiment of the present inventive concept, the second data voltage may be smaller than the first data voltage by an offset voltage.

In an embodiment of the present inventive concept, the offset voltage may be about 0.2 V.

In an embodiment of the present inventive concept, the display device is configured to generate a first frame that may include the address scan period and the self-scan period following the address scan period, the gate driver may output the first gate signal and the bias write scan signal in the address scan period, and the gate driver may output the bias write gate signal in the self-scan period.

In an embodiment of the present inventive concept, the gate driver may not output the first gate signal in the self-scan period.

In an embodiment of the present inventive concept, the number of the self-scan periods may increase, as a frequency of the one frame decreases.

In an embodiment of the present inventive concept, the first data voltage may be written to the pixel in the address scan period, and the second data voltage may be not written to the pixel in the self-scan period.

In an embodiment of the present inventive concept, the gate driver may output the first gate signal at a first frequency and may output the bias write gate signal at a second frequency. The first frequency and the second frequency may be different from each other.

In an embodiment of the present inventive concept, the second frequency may be greater than the first frequency.

In an embodiment of the present inventive concept, the pixel may include a light emitting diode, a first transistor configured to output a driving current to the light emitting diode, a second transistor configured to the first data voltage to an input electrode of the first transistor in response to the first gate signal, and a bias writing transistor configured to output a bias voltage to the input electrode of the first transistor in response to the bias write gate signal.

In an embodiment of the present inventive concept, the pixel may further include a third transistor configured to connect an output electrode of the first transistor and a gate electrode of the first transistor in response to a second gate signal and a fourth transistor configured to initialize the gate electrode of the first transistor to a gate initialization voltage.

In an embodiment of the present inventive concept, the first transistor and the second transistor may be PMOS transistors, and the third transistor and the fourth transistor may be NMOS transistors.

In an embodiment of the present inventive concept, the pixel may further include a fifth transistor configured to output a first power voltage to the input electrode of the first transistor in response to the emission control signal, a sixth transistor configured to output the driving current to an anode electrode of the light emitting diode in response to the emission control signal, and a seventh transistor configured to initialize the anode electrode of the light emitting diode to an anode initialization voltage in response to the bias write gate signal.

In an embodiment, a display device includes a display panel having a plurality of pixels connected to a respective first gate line, an emission control line, a bias gate line, and a data line. A gate driver configured to output a first gate signal to the first gate line during an address scan period and configured to output a bias write gate signal to the bias gate line during a self-scan period. An emission driver configured to output an emission control signal during the address scan period and the self-scan period; a data driver configured to output to the display panel a first data voltage during an address scan period of a first frame. The data driver is configured to output to the display panel a second data voltage with an offset voltage during a self-scan period of the first frame.

In an embodiment, the data driver is configured to set the first data voltage and the second data voltage to stabilize a boundary light waveform of the display between the address scan period and the self-scan period of the first frame

Therefore, a display device according to embodiments of the present inventive concept may be driven with a variable frequency, and one frame may have an address scan period and at least one self-scan period. A data driver of the display device may output a first data voltage in the address scan period and may output a second data voltage during the self-scan period. As the second data voltage is set based on the first data voltage, the light waveform of the display device may be stably repeated during a timing when the self-scan period following the address scan period starts. Accordingly, the flicker of the display device may be reduced.

It is to be understood that both the foregoing general description and the following detailed description are examples and are intended to provide further explanation of the inventive concept as claimed.

### BRIEF DESCRIPTION OF THE DRAWINGS

The accompanying drawings, which are included to provide a further understanding of the inventive concept and are incorporated in and constitute a part of this specification, illustrate embodiments of the inventive concept together with the description.

FIG. 1 is a block diagram illustrating a display device according to an embodiment of the present inventive concept.

FIGS. 2 and 3 are conceptual views illustrating a method of driving the display device of FIG. 1.

FIG. 4 is a circuit diagram illustrating a pixel included in the display device of FIG. 1.

FIG. 5 is a cross-sectional view illustrating the display device of FIG. 1.

FIG. 6 is a timing diagram illustrating operation of the display device of FIG. 1.

FIG. 7 is a timing diagram illustrating operation of a display device according to another embodiment of the present inventive concept.

FIG. 8 is a timing diagram illustrating operation of a display device according to still another embodiment of the present inventive concept.

FIG. 9 is a block diagram illustrating an electronic device including the display device of FIG. 1.

### DETAILED DESCRIPTION

Illustrative, non-limiting embodiments of the present inventive concept will be more clearly understood from the following detailed description in conjunction with the accompanying drawings.

Herein, when one value is described as being about equal to another value or being substantially the same as or equal to another value, it is to be understood that the values are equal to each other to within a measurement error, or if measurably unequal, are close enough in value to be functionally equal to each other as would be understood by a person having ordinary skill in the art. For example, the term “about” as used herein is inclusive of the stated value and means within an acceptable range of deviation for the particular value as determined by one of ordinary skill in the art, considering the measurement in question and the error associated with measurement of the particular quantity (e.g, the limitations of the measurement system). For example, “about” may mean within one or more standard deviations as understood by one of the ordinary skill in the art. Further, it is to be understood that while parameters may be described herein as having “about” a certain value, according to exemplary embodiments, the parameter may be exactly the certain value or approximately the certain value within a measurement error as would be understood by a person having ordinary skill in the art.

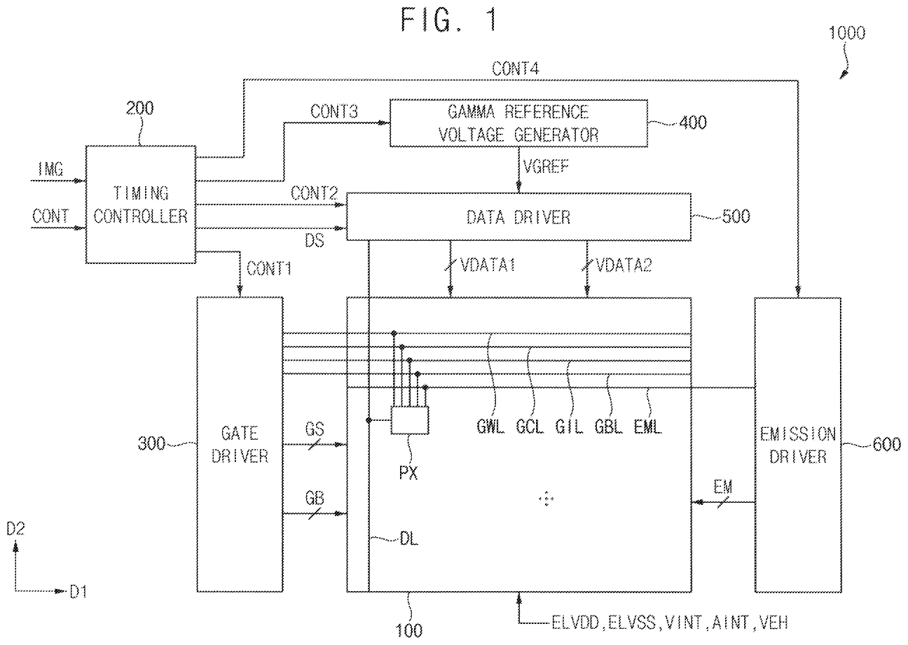

FIG. 1 is a block diagram illustrating a display device according to an embodiment of the present inventive concept.

Referring to FIG. 1, a display device 1000 according to an embodiment of the present inventive concept may include a display panel 100 and a driver. The driver may include a timing controller 200, a gate driver 300, a gamma reference voltage generator 400, a data driver 500, and an emission driver 600.

The display panel 100 may include at least one gate line, at least one emission control line, at least one bias gate line, and at least one data line. In addition, the display panel 100 may include at least one pixel connected to the above-described lines.

For example, the display panel 100 may include a first gate line GWL, a second gate line GCL, a third gate line GIL, a bias gate line GBL, an emission control line EML, and a data line DL. In addition, the display panel 100 may include a pixel PX connected to the first gate line GWL, the second gate line GCL, the third gate line GIL, the bias gate line GBL, the emission control line EML, and the data line DL.

In an embodiment of the present inventive concept, the first gate line GWL, the second gate line GCL, the third gate line GIL, the bias gate line GBL, and the emission control line EML may extend in a first direction D1. The data line DL may extend in a second direction D2 traversing the first direction D1. The arrangement of the display panel 100 relative to the items 200-600 is not limited to the arrangement as shown in FIG. 1.

The timing controller 200 may receive an input image data IMG and an input control signal CONT from an external device (e.g., GPU).

In an embodiment of the present inventive concept, the input image data IMG may include red image data, green image data, and blue image data. In another embodiment, the input image data IMG may further include white image data. In still another embodiment, the input image data IMG may include magenta image data, yellow image data, and cyan image data.

In an embodiment of the present inventive concept, the input control signal CONT may include a master clock signal and a data enable signal. In addition, the input control signal CONT may further include a vertical synchronization signal and a horizontal synchronization signal.

The timing controller 200 may be configured to generate a first control signal CONT1, a second control signal CONT2, a third control signal CONT3, a fourth control signal CONT4, and a data signal DS, based on the input image data IMG and the input control signal CONT. The timing controller 200 may generate more than the four control signals shown and described.

The timing controller 200 may be configured to generate the first control signal CONT1 based on the input control signal CONT. The first control signal CONT1 may be supplied to the gate driver 300, and may control an operation of the gate driver 300. For example, the first control signal CONT1 may include a vertical start signal and a clock signal.

The timing controller 200 may be configured to generate the second control signal CONT2 based on the input control signal CONT. The second control signal CONT2 may be supplied to the data driver 500 and may control an operation of the data driver 500. For example, the second control signal CONT2 may include a horizontal start signal and a load signal.

The timing controller 200 may be configured to generate the third control signal CONT3 based on the input control signal CONT. The third control signal CONT3 may be supplied to the gamma reference voltage generator 400, and may control an operation of the gamma reference voltage generator 400.

The timing controller 200 may be configured to generate the fourth control signal CONT4 based on the input control signal CONT. The fourth control signal CONT4 may be supplied to the emission driver 600 and may control an operation of the emission driver 600. For example, the fourth control signal CONT4 may include a vertical start signal and a clock signal.

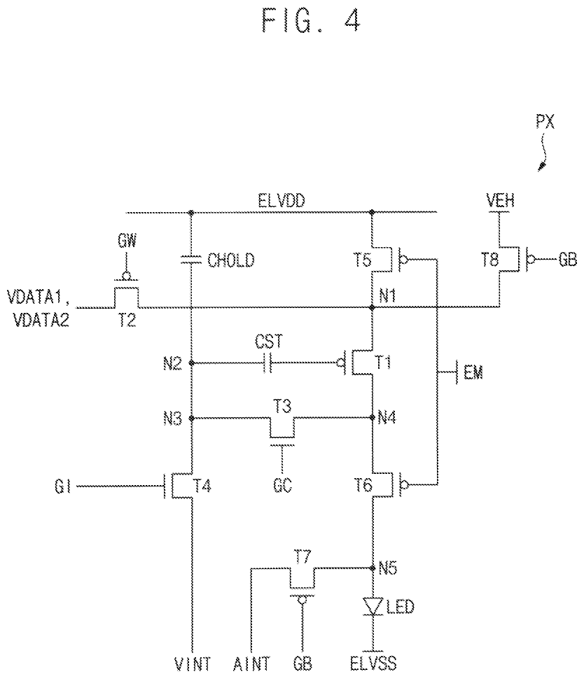

The gate driver 300 may be configured to generate a gate signal GS based on the first control signal CONTI. The gate signal GS may be supplied to the pixel PX, and may control driving of the pixel PX. For example, the gate signal GS may include a first gate signal (e.g., a first gate signal GW of FIG. 4), a second gate signal (e.g., a second gate signal GC of FIG. 4), and a third gate signal (e.g., a third gate signal GI of FIG. 4).

The gate driver 300 may output the first gate signal GW to the first gate line GWL, may output the second gate signal GC to the second gate line GCL, and may output the third gate signal GI to the third gate line GIL.

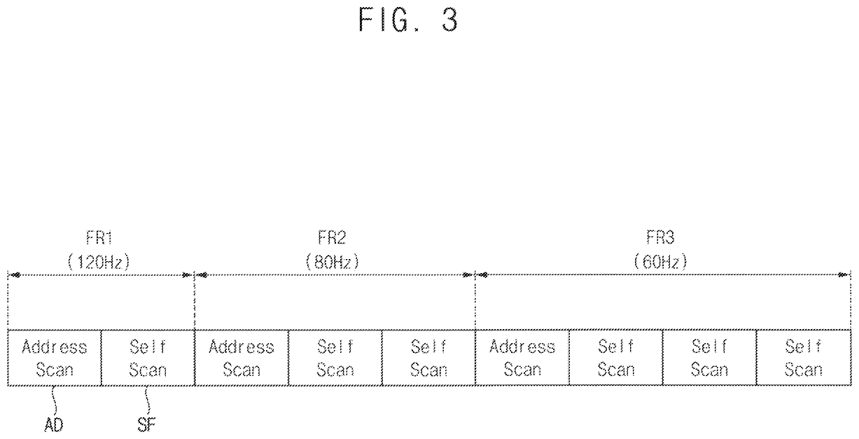

In an embodiment, the gate driver 300 may output the first gate signal GW in an address scan period (e.g., an address scan period AD of FIG. 3). In this case, the gate driver 300 may not output the first gate signal GW during a self-scan period (e.g., see a self-scan period SF of FIG. 3).

In addition, the gate driver 300 may output the second gate signal GC and the third gate signal GI in the address scan period AD. In this case, the gate driver 300 may not output the second gate signal GC and the third gate signal GI in the self-scan period SF.

The gate driver 300 may be configured to generate a bias write gate signal GB based on the received first control signal CONT1. The bias write gate signal GB may be supplied to the pixel PX, and may control driving of the pixel PX.

The gate driver 300 may output the bias write gate signal GB to the bias gate line GBL. In an embodiment, the gate driver 300 may output the bias write gate signal GB in the address scan period AD and the self-scan period SF.

In an embodiment, the gate driver 300 may output the first gate signal GW at a first frequency and may output the bias write gate signal GB at a second frequency. In this case, the first frequency and the second frequency may be different from each other. For example, the second frequency may be greater than the first frequency. The first frequency may be about, for example, 120 Hz, and the second frequency may be about, for example, 240 Hz.

The gamma reference voltage generator 400 may be configured to generate a gamma reference voltage VGREF based on the third control signal CONT3. The gamma reference voltage VGREF 400 may have a value corresponding to the data signal DS, and may be supplied to the data driver 500.

For example, the gamma reference voltage generator 400 may be disposed in the timing controller 200 or in the data driver 500 in addition to the separately arranged as shown.

The data driver 500 may receive the second control signal CONT2 and the data signal DS from the timing controller 200, and may receive the gamma reference voltage VGREF from the gamma reference voltage generator 400.

The data driver 500 may be configured to convert the data signal DS into a data voltage using the gamma reference voltage VGREF. For example, the data voltage may include a first data voltage VDATA1 and a second data voltage VDATA2. The data driver 500 may output the first data voltage VDATA1 and the second data voltage VDATA2 to the data line DL.

In an embodiment, the first data voltage VDATA1 may be provided during a portion of the address scan period AD, and the second data voltage VDATA2 may be provided during a portion of the self-scan period SF. The first data voltage VDATA1 may be written to the pixel PX in the address scan period AD. The second data voltage VDATA2 may not be written to the pixel PX during the self-scan period SF.

The emission driver 600 may generate the emission control signal EM based on the fourth control signal CONT4. The emission control signal EM may be supplied to the pixel PX through the emission control line EML, and may control driving of the pixel PX.

In an embodiment, the emission driver 600 may output the emission control signal EM to the address scan period AD and the self-scan period SF.

Although the gate driver 300 disposed on a first side of the display panel 100 and the emission driver 600 disposed in a second side of the display panel 100 is shown in FIG. 1, but the present inventive concept is not limited thereto. For example, both the gate driver 300 and the emission driver 600 may be disposed on the first side of the display panel 100. In addition, the gate driver 300 and the emission driver 600 may be integrally formed.

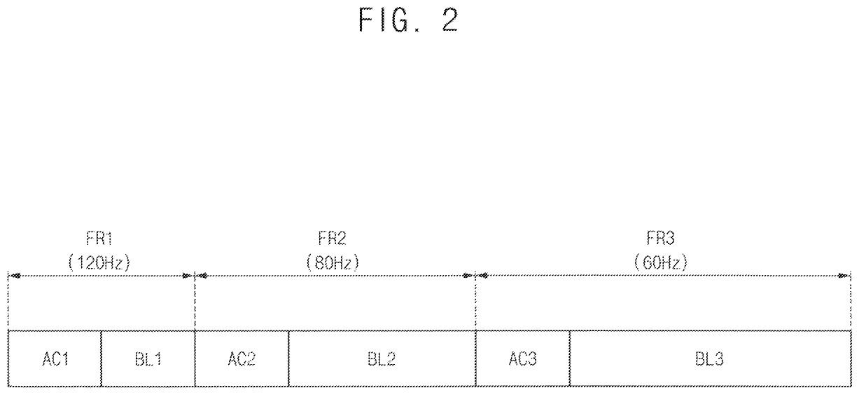

FIGS. 2 and 3 are conceptual views illustrating a method of driving the display device of FIG. 1.

Referring to FIG. 2, the display device 1000 may be driven at a variable frequency. A first frame FR1 may include a first active period AC1 and a first blank period BL1. In this embodiment, the first frame FR1 may have a frequency of 120 Hz. The first blank period BL1 may follow the first active period AC1. The second frame FR2 may include a second active period AC2 and a second blank period BL2. In this embodiment, the second frame FR2 may have a frequency of 80 Hz. The second active period AC2 may follow the first blank period BL1, and the second blank period BL2 may follow the second active period AC2. The third frame FR3 may include a third active period AC3 and a third blank period BL3. In this embodiment, the third frame FR3 may have a frequency of 60 Hz The third active period AC3 may follow the second blank period BL2, and the third blank period BL3 may follow the third active period AC3.

In an embodiment, the first frame FR1, the second frame FR2, and the third frame FR3 may have different frequencies. For example, as shown in FIG. 2, the first frame FR1 may have a frequency of about 120 Hz, the second frame FR2 may have a frequency of about 80 Hz, and the third frame FR3 may have a frequency of about 60 Hz.

In an embodiment, the first active period AC1 may have a duration that is the same as a duration of the second active period AC2. The second active period AC2 may have a duration the same as a length of the third active period AC3.

In an embodiment, the first blank period BL1 may have a duration different from a duration of the second blank period BL2. The second blank period BL2 may have a duration different from a duration of the third blank period BL3.

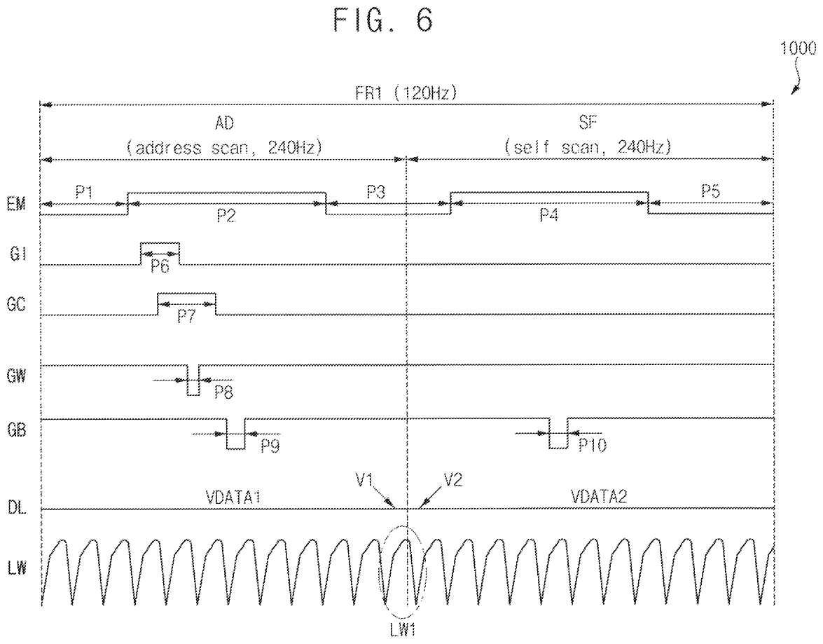

The display device 1000, which supports a variable frequency, may include a data writing period (e.g., an eighth period P8 of FIG. 6) in which the first data voltage VDATA1 is written to the pixel PX and the self-scan period SF in which the data voltage is not written to the pixel PX. The data writing period may be arranged in the first active period AC1, the second active period AC2, and the third active period AC3, respectively. The self-scan period SF may be arranged in the first blank period BLL1, the second blank period BL2, and the third blank period BL3, respectively.

Referring to FIG. 3, the first frame FR1 may have one address scan period AD and one self-scan period SF. The address scan period AD included in the first frame FR1 may correspond to the first active period AC1 described with reference to FIG. 2. The self-scan period SF included in the first frame FR1 may correspond to the first blank period BL1 described with reference to FIG. 2.

With continued reference to FIG. 3, the second frame FR2 may include one address scan period and two self-scan periods. The two self-scan periods may be continuous with each other. The address scan period included in the second frame FR2 may correspond to the second active period AC2 described with reference to FIG. 2. The self-scan periods included in the second frame FR2 may correspond to the second blank period BL2 described with reference to FIG. 2.

The third frame FR3 may include one address scan period and three self-scan periods. The three self-scan periods may be continuous with each other. The address scan period included in the third frame FR3 may correspond to the third active period AC3 described with reference to FIG. 2. The self-scan periods included in the third frame FR3 may correspond to the third blank period BL3 described with reference to FIG. 2.

FIG. 4 is a circuit diagram illustrating a pixel included in the display device of FIG. 1 according to an embodiment of the present inventive concept.

Referring to FIG. 4, the pixel PX may include a light emitting diode LED, a first transistor T1, a second transistor T2, a third transistor T3, a fourth transistor T4, a fifth transistor T5, a sixth transistor T6, a seventh transistor T7, a bias writing transistor T8, a hold capacitor CHOLD, and a storage capacitor CST.

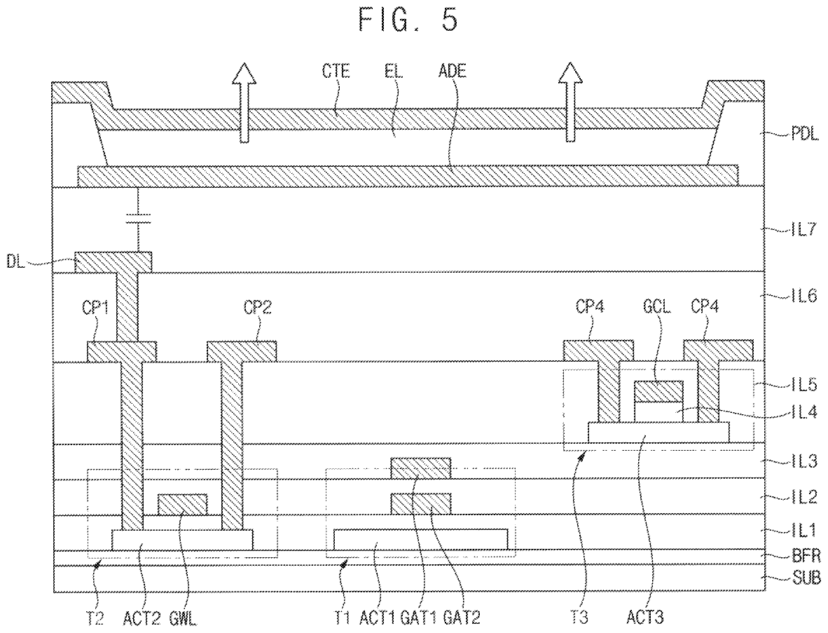

The light emitting diode LED may include an anode electrode (e.g., an anode electrode ADE shown in FIG. 5), an emission layer (e.g., an emission layer EL shown in FIG. 5), and a cathode electrode (e.g., a cathode electrode CTE). The anode electrode may receive a driving current, and the emission layer may emit light having a luminance corresponding to the driving current. The cathode electrode may be connected to a second power voltage ELVSS.

The first transistor T1 may include an input electrode, an output electrode, and a gate electrode. The input electrode of the first transistor T1 may be connected to a first node N1. The output electrode of the first transistor T1 may be connected to the anode electrode of the light emitting diode LED through a fourth node N4. The gate electrode of the first transistor T1 may be connected to a second node N2 through the storage capacitor CST. The first transistor T1 may provide the driving current to the light emitting diode LED. For example, the first transistor T1 may be referred to as a driving transistor.

The second transistor T2 may include an input electrode, an output electrode, and a gate electrode. The input electrode of the second transistor T2 may be connected to the data line DL. Accordingly, the first data voltage VDATA1 and the second data voltage VDATA2 may be provided to the input electrode of the second transistor T2. The output electrode of the second transistor T2 may be connected to the first node N1. The gate electrode of the second transistor T2 may receive the first gate signal GW. The second transistor T2 may transmit the first data voltage VDATA1 to the first transistor T1 in response to the first gate signal GW. In an embodiment, the first data voltage VDATA1 may be written to the pixel PX through the second transistor T2 in the address scan period AD. For example, the second transistor T2 may be referred to as a data writing transistor.

With continued reference to FIG. 4, the third transistor T3 may include an input electrode, an output electrode, and a gate electrode. The input electrode of the third transistor T3 may be connected to the fourth node N4. The output electrode of the third transistor T3 may be connected to the second node N2 through a third node N3. The gate electrode of the third transistor T3 may receive the second gate signal GC. The third transistor T3 may diode-connect the output electrode of the first transistor T1 and the gate electrode of the first transistor T1 in response to the second gate signal GC. For example, the third transistor T3 may be referred to as a compensation transistor.

The fourth transistor T4 may include an input electrode, an output electrode, and a gate electrode. The input electrode of the fourth transistor T4 may receive a gate initialization voltage VINT. The output electrode of the fourth transistor T4 may be connected to the second node N2. The gate electrode of the fourth transistor T4 may receive the third gate signal GI. The fourth transistor T4 may initialize the gate electrode of the first transistor T1 to the gate initialization voltage VINT in response to the third gate signal GI. For example, the fourth transistor T4 may be referred to as a gate initialization transistor.

The fifth transistor T5 may include an input electrode, an output electrode, and a gate electrode. The input electrode of the fifth transistor T5 may receive a first power voltage ELVDD. The output electrode of the fifth transistor T5 may be connected to the first node N1. The gate electrode of the fifth transistor T5 may receive the emission control signal EM. The fifth transistor T5 may provide the first power voltage ELVDD to the input electrode of the first transistor T1 in response to the emission control signal EM. For example, the fifth transistor T5 may be referred to as a first emission transistor.

The sixth transistor T6 may include an input electrode, an output electrode, and a gate electrode. The input electrode of the sixth transistor T6 may be connected to the fourth node N4. The output electrode of the sixth transistor T6 may be connected to the light emitting diode LED through a fifth node N5. The gate electrode of the sixth transistor T6 may receive the emission control signal EM. The sixth transistor T6 may provide the driving current to the anode electrode of the light emitting diode LED in response to the emission control signal EM. For example, the sixth transistor T6 may be referred to as a second emission transistor.

The seventh transistor T7 may include an input electrode, an output electrode, and a gate electrode. The input electrode of the seventh transistor T7 may receive an anode initialization voltage AINT. The output electrode of the seventh transistor T7 may be connected to the light emitting diode LED through the fifth node N5. The gate electrode of the seventh transistor T7 may receive the bias write gate signal GB. The seventh transistor T7 may initialize the anode electrode of the light emitting diode LED to the anode initialization voltage AINT in response to the bias write gate signal GB. For example, the seventh transistor T7 may be referred to as an anode initialization transistor.

The bias writing transistor T8 may include an input electrode, an output electrode, and a gate electrode. The input electrode of the bias writing transistor T8 may receive a bias voltage VEH. The output electrode of the bias writing transistor T8 may be connected to the first node N1. The gate electrode of the bias writing transistor T8 may receive the bias write gate signal GB. The bias writing transistor T8 may transmit the bias voltage VEH to the input electrode of the first transistor T1 in response to the bias write gate signal GB.

In an embodiment, the first, second, fifth, sixth, and seventh transistors T1, T2, T5, T6, and T7 may be PMOS transistors, and the third and fourth transistors T3 and T4 may be NMOS transistors. However, it is to be understood that there may be different quantities of PMOS and NMOS transistors.

The storage capacitor CST may be connected between the gate electrode of the first transistor T1 and the second node N2, and the hold capacitor CHOLD may be connected between the first power voltage ELVDD and the second node N2.

FIG. 5 is a cross-sectional view illustrating the display device of FIG. 1.

Referring to FIG. 5, the display device 1000 may include a substrate SUB, a buffer layer BFR arranged on the substrate SUB, a first active pattern ACT1, a second active pattern ACT2, a first insulating layer IL1 a first gate electrode GAT1, the first gate line GWL, a second insulating layer IL2, a second gate electrode GAT2, a third insulating layer IL3, a third active pattern ACT3, a fourth insulating layer IL4, the second gate line GCL, a fifth insulating layer IL5, a first connection pattern CP1, a second connection pattern CP2, a third connection pattern CP3, a fourth connection pattern CP4, a sixth insulating layer IL6, the data line DL, a seventh insulating layer IL7, the anode electrode ADE, a pixel defining layer PDL, the emission layer EL, and the cathode electrode CTE.

The substrate SUB may be formed of glass, quartz, plastic, or the like. Examples of the material that can be used as the plastic may include polyimide (“PI”), polyacrylate, polymethylmethacrylate (“PMMA”), polycarbonate (“PC”), polyethylenenaphthalate (“PEN”), polyvinylidene chloride, polyvinylidene difluoride (“PVDF”), polystyrene, ethylene vinylalcohol copolymer, polyethersulphone (“PES”), polyetherimide (“PEI”), polyphenylene sulfide (“PPS”), polyallylate, tri-acetyl cellulose (“TAC”), cellulose acetate propionate (“CAP”), and so on. These may be used alone or in combination with each other.

The buffer layer BFR may be disposed on the substrate SUB. In an embodiment, the buffer layer BFR may be formed of an inorganic material. Examples of the inorganic material may include silicon oxide, silicon nitride, silicon oxynitride, and the like. These may be used alone or in combination with each other. The buffer layer BFR may prevent metal atoms or impurities from penetrating into the first and second active patterns ACT1 and ACT2. In addition, the buffer layer BFR may control a heat output rate during a crystallization process for forming the first and second active patterns ACT1 and ACT2.

The first and second active patterns ACT1 and ACT2 may be disposed on the buffer layer BFR. In an embodiment, the first and second active patterns ACT1 and ACT2 may be formed of a silicon semiconductor material. Examples of the silicon semiconductor material that may be used as the first and second active patterns ACT1 and ACT2 may include amorphous silicon and polycrystalline silicon. These may be used alone or in combination with each other.

The first insulating layer IL1 may be disposed on the buffer layer BFR and may cover the first and second active patterns ACT1 and ACT2. In an embodiment, the first insulating layer IL1 may be formed of an insulating material. Examples of the insulating material that can be used as the first insulating layer IL1 may include silicon oxide, silicon nitride, silicon oxynitride, and the like. These may be used alone or in combination with each other.

The first gate electrode GAT1 and the first gate line GWL may be disposed on the first insulating layer IL1. In an embodiment, the first gate electrode GAT1 may overlap the first active pattern ACT1. The first active pattern ACT1 and the first gate electrode GAT1 may constitute the first transistor T1. In an embodiment, the first gate line GWL may overlap the second active pattern ACT2. The second active pattern ACT2 and the first gate line GWL may constitute the second transistor T2.

In an embodiment, the first gate electrode GAT1 and the first gate line GWL may be formed of a metal, an alloy, a conductive metal oxide, a transparent conductive material, or the like. Examples of materials that can be used as the first gate electrode GAT1 and the first gate line GWL may include silver (“Ag”), an alloy containing silver, molybdenum (“Mo”), an alloy containing molybdenum, aluminum (“Al”), an alloy containing aluminum, aluminum nitride (“AlN”), tungsten (“W”), tungsten nitride (“WN”), copper (“Cu”), nickel (“Ni”), chromium (“Cr”), chromium nitride (“CrN”), titanium (“Ti”), tantalum (“Ta”), platinum (“Pt”), scandium (“Sc”), indium tin oxide (“ITO”), indium zinc oxide (“IZO”), or the like. These may be used alone or in combination with each other.

The second insulating layer IL2 may be disposed on the first insulating layer IL1 and may cover the first gate electrode GAT1 and the first gate line GWL. In an embodiment, the second insulating layer IL2 may be formed of an insulating material.

The second gate electrode GAT2 may be disposed on the second insulating layer IL2. In an embodiment, the second gate electrode GAT2 may overlap the first gate electrode GAT1. The first gate electrode GAT1 and the second gate electrode GAT2 may constitute the storage capacitor CST. In an embodiment, the second gate electrode GAT2 may be formed of a metal, an alloy, a conductive metal oxide, a transparent conductive material, or the like.

The third insulating layer IL3 may be disposed on the second insulating layer IL2 and cover the second gate electrode GAT2. In an embodiment, the third insulating layer IL3 may be formed of an insulating material.

The third active pattern ACT3 may be disposed on the third insulating layer IL3. In an embodiment, the third active pattern ACT3 may be formed of an oxide semiconductor material. Examples of the oxide semiconductor material that may be used as the third active pattern ACT3 may be IGZO (InGaZnO), ITZO (InSnZnO), or the like. In addition, the oxide semiconductor material may further include indium (“In”), gallium (“Ga”), tin (“Sn”), zirconium (“Zr”), vanadium (“V”), hafnium (“Hf”), cadmium (“Cd”), germanium (“Ge”), chromium (“Cr”), titanium (“Ti”), and zinc (“Zn”). These may be used alone or in combination with each other.

The fourth insulating layer IL4 may be disposed on the third active pattern ACT3. In an embodiment, the fourth insulating layer IL4 may be formed of an insulating material.

The second gate line GCL may be disposed on the fourth insulating layer IL4. In an embodiment, the second gate line GCL may overlap the third active pattern ACT3. The third active pattern ACT3 and the second gate line GCL may constitute the third transistor T3.

The fifth insulating layer IL5 may be disposed on the fourth insulating layer IL4 and may cover the second gate line GCL. In an embodiment, the fifth insulating layer IL5 may be formed of an insulating material.

The first to fourth connection patterns CP1, CP2, CP3, and CP4 may be disposed on the fifth insulating layer IL5. The first and second connection patterns CP1 and CP2 may contact the second active pattern ACT2. The third and fourth connection patterns CP3 and CP4 may contact the third active pattern ACT3. In an embodiment, the first to fourth connection patterns CP1, CP2, CP3, and CP4 may be formed of a metal, an alloy, a conductive metal oxide, a transparent conductive material, or the like.

The sixth insulating layer IL6 may be disposed on the fifth insulating layer IL5 and may be sized to cover the first to fourth connection patterns CP1, CP2, CP3, and CP4. In an embodiment, the sixth insulating layer IL6 may be formed of an organic material. Examples of the organic material may include photoresists, polyacrylic resins, polyimide resins, acrylic resins, and the like. These may be used alone or in combination with each other. Accordingly, the sixth insulating layer IL6 may have a substantially flat top surface.

The data line DL may be disposed on the sixth insulating layer IL6. In an embodiment, the data line DL may contact the first connection pattern CP1. The first data voltage VDATA1 and the second data voltage VDATA2 may be provided to the data line DL. In an embodiment, the data line DL may be formed of a metal, an alloy, a conductive metal oxide, a transparent conductive material, or the like.

The seventh insulating layer IL7 is disposed on the sixth insulating layer IL6 and may cover the data line DL. In an embodiment, the seventh insulating layer IL7 may be formed of an organic material. 1001071 The anode electrode ADE may be disposed on the seventh insulating layer IL7. In an embodiment, the anode electrode ADE may be formed of a metal, an alloy, a conductive metal oxide, a transparent conductive material, or the like.

The pixel defining layer PDL may be disposed on the seventh insulating layer IL7. An opening exposing the anode electrode ADE may be formed in the pixel defining layer PDL. In an embodiment, the pixel defining layer PDL may be formed of an organic material.

The emission layer EL may be disposed on the anode electrode ADE. The emission layer EL may include an organic material emitting light. In an embodiment, the light emitted from the emission layer EL may be emitted toward the cathode electrode CTE.

The cathode electrode CTE may be disposed on the emission layer EL. The cathode electrode CTE may receive the second power voltage ELVSS.

The emission layer EL may emit light based on a voltage difference between the anode electrode ADE and the cathode electrode CTE. The second power voltage ELVSS provided to the cathode electrode CTE may be a constant voltage having a fixed value. In this case, the light waveform (e.g., a light waveform LW of FIG. 6) emitted from the emission layer EL may be changed based on a potential value of the anode electrode ADE.

In an embodiment, a parasitic capacitance may be formed between the data line DL and the anode electrode ADE. Accordingly, when the data voltage flowing through the data line DL is changed, the potential value of the anode electrode ADE may be changed. Moreover, when the data voltage applied to the data line DL is changed, the light waveform LW may be unstable.

For example, during a timing from the address scan period AD to the self-scan period SF, a boundary light waveform (e.g., the boundary light waveform LW1 in FIG. 6) may be unstable. Accordingly, a flicker of the display device may be deteriorated.

In the display device 1000, the first data voltage VDATA1 may be supplied to the data line DL in the address scan period AD, and the second data voltage VDATA2 may be supplied in the self-scan period SF. The second data voltage VDATA2 may be set based on the first data voltage VDATA1. In an embodiment, the second data voltage VDATA2 may be the same as the first data voltage VDATA1. Accordingly, during the timing from the address scan period AD to the self-scan period SF, the boundary light waveform LW1 may be stably repeated. Accordingly, the flicker of the display device 1000 may be reduced.

FIG. 6 is a timing diagram illustrating operation of the display device of FIG. 1.

Referring to FIGS. 3, 4, and 6, the display device 1000 may be driven at about 120 Hz during the first frame FR1. The first frame FR1 may include the address scan period AD and the self-scan period SF.

The emission control signal EM may have a turn-on voltage during a first period P1, a third period P3, and a fifth period P5, and may have a turn-off voltage during a second period P2 and a fourth period P4. While the emission control signal EM has the turn-on voltage, the display device 1000 may emit light. In an embodiment, the emission control signal EM may be supplied at the second frequency (e.g., about 240 Hz).

The third gate signal GI may have a turn-on voltage during a sixth period P6. In an embodiment, the sixth period P6 may overlap the second period P2. During the sixth period P6, the gate electrode of the first transistor T1 may be initialized. In an embodiment, the third gate signal GI may be supplied at the first frequency (e.g., about 120 Hz).

The second gate signal GC may have a turn-on voltage during the seventh period P7. In an embodiment, the seventh period P7 may overlap the second period P2. During the seventh period P7, the threshold voltage of the first transistor T1 may be compensated. In an embodiment, the second gate signal GC may be supplied at the first frequency.

The first gate signal GW may have a turn-on voltage during the eighth period P8. In an embodiment, the eighth period P8 may overlap the second period P2 and the seventh period P7. During the eighth period P8, the first data voltage VDATA1 may be written to the pixel PX. In an embodiment, the first gate signal GW may be supplied at the first frequency. For example, the eighth period P8 may be referred to as the data writing period.

The bias write gate signal GB may have a turn-on voltage during a ninth period P9 and a tenth period P10. In an embodiment, the ninth period P9 may overlap the second period P2, and the tenth period P10 may overlap the fourth period P4. The bias voltage VEH may be written to the pixel PX during the ninth period P9 and the tenth period P10. In an embodiment, the bias write gate signal GB may be supplied at the second frequency.

The first data voltage VDATA1 may be supplied to the data line DL in the address scan period AD, and the second data voltage VDATA2 may be supplied in the self-scan period SF. In an embodiment, the second data voltage VDATA2 may be the same as the first data voltage VDATA1. For example, the first data voltage VDATA1 may have a first voltage V1 at a timing at which the address scan period AD ends. The second data voltage VDATA2 may have a second voltage V2 at a timing when the self-scan period SF starts. The second voltage V2 may be the same as the first voltage V1.

As the second data voltage VDATA2 is set equal to the first data voltage VDATA1, the light waveform LW may be stably repeated. In other words, as the first data voltage VDATA1 is supplied to the data line DL during the address scan period AD, and the second data voltage VDATA2 same as the first data voltage VDATA1 is supplied to the data line DL during the self-scan period SF, the display device 1000 may have a stable boundary light waveform LW1.

In FIG. 6, the first frame FR1 having one address scan period AD and one self-scan period SF has been described, but the present inventive concept is not limited thereto. For example, one frame may have one address scan period and a plurality of self-scan periods. In this case, the data voltage may be equally supplied to the data line DL during the address scan period and the self-scan periods.

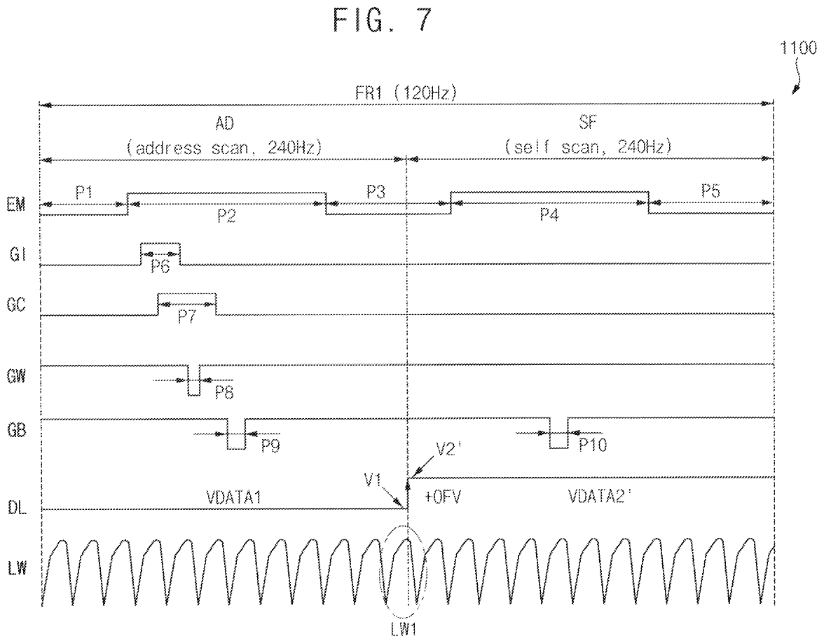

FIG. 7 is a timing diagram illustrating operation of a display device according to another embodiment of the present inventive concept.

Referring to FIGS. 3, 4, 6, and 7, a display device 1100 according to another embodiment may be driven at about 120 Hz during the first frame FR1. However, the display device 1100 may be substantially the same as the display device 1000 described above, except for a second data voltage VDATA2′ supplied to the data line DL in the self-scan period SF.

The first data voltage VDATA1 may be supplied to the data line DL in the address scan period AD, and the second data voltage VDATA2′ may be provided to the data line DL in the self-scan period SF. In an embodiment, the second data voltage VDATA2′ may be greater than the first data voltage VDATA1 by an offset voltage OFV. For example, the first data voltage VDATA1 may have the first voltage V1 at a timing at which the address scan period AD ends. The second data voltage VDATA2′ may have a second voltage V2′ at a timing when the self-scan period SF starts. The second voltage V2′ may be greater than the first voltage V1 by the offset voltage OFV. The offset voltage OFV may be any voltage stabilizing the light waveform LW. For example, the offset voltage OFV may be about 0.2 V.

As the second data voltage VDATA2′ is set to be greater than the first data voltage VDATA1 by the offset voltage OFV, the light waveform LW may be stably repeated. In other words, as the first data voltage VDATA1 is supplied to the data line DL in the address scan period AD, and the second data voltage VDATA2′ greater than the first data voltage VDATA1 by the offset voltage OFV is supplied to the data line DL, the display device 1100 may have a stable boundary light waveform LW1.

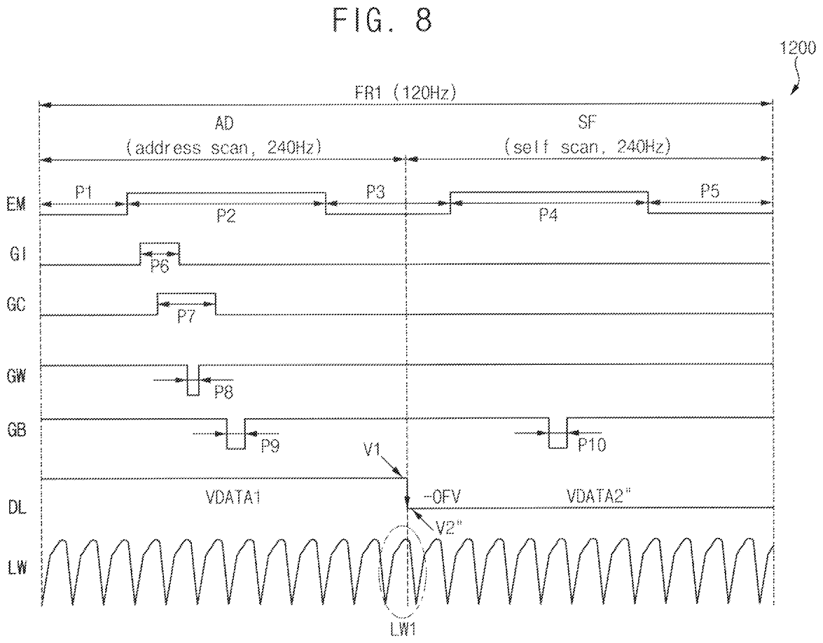

FIG. 8 is a timing diagram illustrating operation of a display device according to still another embodiment of the present inventive concept.

Referring to FIGS. 3, 4, 6, and 8, a display device 1200 according to still another embodiment may be driven at about 120 Hz during the first frame FR1. However, the display device 1200 may be substantially the same as the display device 1000 described above, except for a second data voltage VDATA2″ supplied to the data line DL in the self-scan period SF.

The first data voltage VDATA1 may be supplied to the data line DL in the address scan period AD, and the second data voltage VDATA2″ may be supplied to the data line DL during the self-scan period SF. In an embodiment, the second data voltage VDATA2″ may be smaller than the first data voltage VDATA1 by an offset voltage OFV. For example, the first data voltage VDATA1 may have the first voltage V1 at a timing at which the address scan period AD ends. The second data voltage VDATA2″ may have a second voltage V2″ at a timing when the self-scan period SF starts. The second voltage V2″ may be smaller than the first voltage V1 by the offset voltage OFV. The offset voltage OFV may be any voltage stabilizing the light waveform LW. For example, the offset voltage OFV may be about 0.2 V.

As the second data voltage VDATA2″ is set to be smaller than the first data voltage VDATA1 by the offset voltage OFV, the light waveform LW may be stably repeated. In other words, as the first data voltage VDATA1 is supplied to the data line DL in the address scan period AD, and the second data voltage VDATA2″ smaller than the first data voltage VDATA1 by the offset voltage OFV is supplied to the data line DL, the display device 1200 may have a stable boundary light waveform LW1.

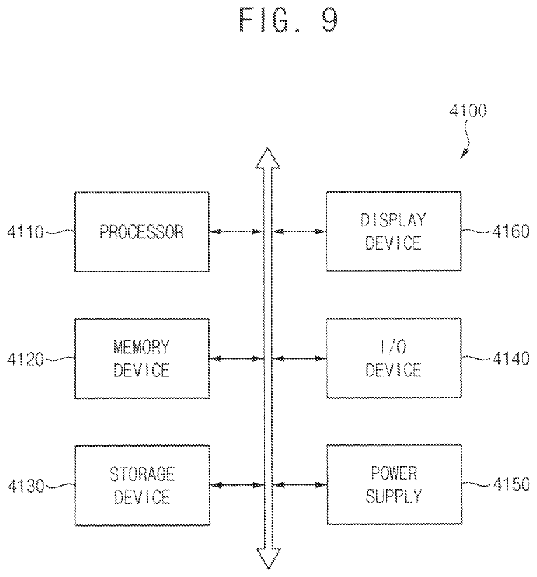

FIG. 9 is a block diagram illustrating an electronic device including the display device of FIG. 1.

Referring to FIG. 9, an electronic device 4100 may include a processor 4110, a memory device 4120, a storage device 4130, an input/output device 4140, a power output 4150, and a display device 4160.

The electronic device 4100 may further include various ports capable of communicating with a video card, a sound card, a memory card, a USB device, or the like, or communicating with other systems.

The processor 4110 may perform specific calculations or tasks. In an embodiment, the processor 4110 may be a circuit, for example, a microprocessor, a central processing unit (CPU), or the like. The processor 4110 may be connected to other components through an address bus, a control bus, and a data bus. In other embodiments, the processor 4110 may also be coupled to an expansion bus, such as a peripheral component interconnect (PCI) bus.

The memory device 4120 may store data necessary for an operation of the electronic device 4100. For example, the memory device 4120 may include non-volatile memory devices such as an Erasable Programmable Read-Only Memory (EPROM), an Electrically Erasable Programmable Read-Only Memory (EEPROM), a Flash Memory, a Phase Change Random Access Memory (PRAM), an Resistance Random Access Memory (RRAM), Nano Floating Gate Memory (NFGM), Polymer Random Access Memory (PoRAM), Magnetic Random Access Memory (MRAM), Ferroelectric Random Access Memory (FRAM), etc. and/or volatile memory devices such as Dynamic Random Access Memory (DRAM), Static Random Access Memory (SRAM), mobile DRAM, etc.

The storage device 4130 may include a solid state drive (SSD), a hard disk drive (HDD), a CD-ROM, and the like. The input/output device 4140 may include input means such as a keyboard, a keypad, a touch pad, a touch screen, a mouse, and an output means such as a speaker and a printer. The power supply 4150 may supply power required for the operation of the electronic device 4100. The display device 4160 may be connected to other components through the buses or other communication links.

The electronic device 4100 may be any electronic device including the display device 4160 such as a mobile phone, a smart phone, a tablet computer, a digital TV, a 3D TV, a personal computer (PC), a home electronic device, laptop computer, Personal Digital Assistant (PDA), Portable Multimedia Player (PMP), digital camera, music player, portable game console, navigation, and the like.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A display device comprising:
a pixel connected to a first gate line, an emission control line, a bias gate line, and a data line;
a gate driver configured to output a first gate signal to the first gate line during an address scan period and configured to output a bias write gate signal to the bias gate line during a self- scan period;
an emission driver configured to output an emission control signal during the address scan period and the self-scan period; and
a data driver configured to output a first data voltage and a second data voltage to the data line; and
wherein the second data voltage is set based on the first data voltage.

2. The display device of claim 1, wherein the data driver is configured to output the first data voltage to the data line during the address scan period and configured to output the second data voltage to the data line during the self-scan period.

3. The display device of claim 1, wherein the first data voltage and the second data voltage are set to stabilize a boundary light waveform of the pixel between the address scan period and the self-scan period.

4. The display device of claim 1, wherein the second data voltage output by the data driver is the same as the first data voltage.

5. The display device of claim 1, wherein the second data voltage is greater than the first data voltage by an offset voltage.

6. The display device of claim 5, wherein the offset voltage is about 0.2 V.

7. The display device of claim 1, wherein the second data voltage is smaller than the first data voltage by an offset voltage.

8. The display device of claim 7, wherein the offset voltage is about 0.2 V.

9. The display device of claim 1, configured to generate a first frame including the address scan period and the self-scan period following the address scan period,
wherein the gate driver is configured to supply the first gate signal and the bias write scan signal during the address scan period, and
wherein the gate driver is configured to supply the bias write gate signal during the self-scan period.

10. The display device of claim 9, wherein the gate driver does not supply the first gate signal during the self-scan period.

11. The display device of claim 9, wherein a number of the self-scan periods increase, as a frequency of the first frame decreases.

12. The display device of claim 1, wherein the first data voltage is written to the pixel during the address scan period, and
wherein the second data voltage is not written to the pixel during the self-scan period.

13. The display device of claim 1, wherein the gate driver is configured to output the first gate signal at a first frequency and is configured to output the bias write gate signal at a second frequency, and
wherein the first frequency and the second frequency are different from each other.

14. The display device of claim 13, wherein the second frequency output by the gate driver is greater than the first frequency.

15. The display device of claim 1, wherein the pixel includes:
a light emitting diode;
a first transistor configured to output a driving current to the light emitting diode;
a second transistor configured to the first data voltage to an input electrode of the first transistor in response to the first gate signal; and
a bias writing transistor configured to output a bias voltage to the input electrode of the first transistor in response to the bias write gate signal.

16. The display device of claim 15, wherein the pixel further includes:
a third transistor configured to connect an output electrode of the first transistor and a gate electrode of the first transistor in response to a second gate signal; and
a fourth transistor configured to initialize the gate electrode of the first transistor to a gate initialization voltage.

17. The display device of claim 16, wherein the first transistor and the second transistor are PMOS transistors, and
wherein the third transistor and the fourth transistor are NMOS transistors.

18. The display device of claim 16, wherein the pixel further includes:
a fifth transistor configured to output a first power voltage to the input electrode of the first transistor in response to the emission control signal;
a sixth transistor configured to output the driving current to an anode electrode of the light emitting diode in response to the emission control signal; and
a seventh transistor configured to initialize the anode electrode of the light emitting diode to an anode initialization voltage in response to the bias write gate signal.

19. A display device, comprising:
a display panel including a plurality of pixels connected to a respective first gate line, an emission control line, a bias gate line, and a data line;
a gate driver configured to output a first gate signal to the first gate line during an address scan period and configured to output a bias write gate signal to the bias gate line during a self-scan period;
an emission driver configured to output an emission control signal during the address scan period and the self-scan period; and
a data driver configured to output a first data voltage to the display panel during an address scan period of a first frame, and the data driver configured to output to the display panel a second data voltage with an offset voltage during a self-scan period of the first frame.

20. The display device according to claim 19, wherein the data driver is configured to set the first data voltage and the second data voltage to stabilize a boundary light waveform of the display between the address scan period and the self-scan period of the first frame.
